(19) United States
(12) Patent Application Publication
(10) Pub. No.: US 2024/0184250 A1
(43) Pub. Date: Jun. 6, 2024

(54) ANTENNA SYSTEMS WITH AN EXTENDED GROUND IN A DETACHABLE CRADLE

(71) Applicant: Meta Platforms Technologies, LLC, Menlo Park, CA (US)

(72) Inventors: Md Rashidul Islam, Fremont, CA (US); Zhong Ji, San Jose, CA (US); Yonghua Wei, San Diego, CA (US); Geng Ye, Union City, CA (US); Bruno Cendon Martin, Palo Alto, CA (US)

(21) Appl. No.: 18/061,847

(22) Filed: Dec. 5, 2022

(51) Int. Cl. G04G 17/04; G04G 17/06; H01Q 1/27

(52) U.S. Cl. CPC G04G 17/04; G04G 17/06; H01Q 1/273

(57) ABSTRACT

The disclosed system may include a cradle configured to receive and secure a detachable capsule. The system may further include a printed circuit board mounted within a housing of the cradle. The system may also include a radiating structure positioned on an inner surface of the housing of the cradle. In such cases, the radiating structure may be electrically connected to the PCB of the cradle. Various other mobile electronic devices, apparatuses, and methods of manufacturing are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is a plan view of an example wristband system, according to at least one embodiment of the present disclosure.

FIG. 1B is a side view of the example wristband system of FIG. 1A, according to at least one embodiment of the present disclosure.

FIG. 2A is a perspective view of an example wristband system, according to at least one embodiment of the present disclosure.

FIG. 2B is a side view of another example wristband system, according to at least one embodiment of the present disclosure.

FIG. 2C is a perspective view of another example wristband system, according to at least one embodiment of the present disclosure.

FIGS. 3A and 3B illustrate embodiments of a mobile electronic device in which a capsule is detached from an associated cradle.

FIGS. 4A and 4B illustrate embodiments of a mobile electronic device in which a capsule is attached to an associated cradle.

FIGS. 5A and 5B illustrate embodiments of a mobile electronic device in which a cradle patch is removed and attached, respectively.

FIGS. 5C and 5D illustrate cross-sectional views of a mobile electronic device in which a cradle patch is electrically connected to a capsule.

FIGS. 6A and 6B illustrate embodiments of a 6-pin connector that electrically connects a cradle patch to a capsule in a mobile electronic device.

FIGS. 7A and 7B illustrate alternative embodiments in which a mobile device is not connected to a cradle patch and then is connected to a cradle patch, respectively.

FIGS. 8A-8C illustrate embodiments in which a cradle pouch is formed in different shapes, layouts, or sizes.

FIG. 9 is a flow diagram of an exemplary method for manufacturing a mobile electronic device that implements a cradle patch.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed to a system designed to improve antenna performance in a detachable electronic device by connecting the detachable device to an extended ground in a corresponding cradle device. In other mobile devices, including smartwatches, smartphones, tablets, and similar systems, those devices typically included a structural frame and multiple components mounted to that frame. Those devices were then used as standalone systems, using their own battery, their own processor, and their own antennas. Those devices were not mechanically or electrically coupled to other cradle devices that could affect antenna or other electronic component performance.

In at least some of the embodiments described herein, mobile devices including smartwatches, smartphones, tablets, artificial reality (AR) devices (e.g., as shown in FIG. 11), virtual reality (VR) devices (e.g., as shown in FIG. 12), Internet of Things (IOT) devices, wearable devices, or other mobile devices may include detachable bezels or capsules as well as corresponding docking or cradle portions. As the terms are used herein, a “capsule” may refer to a detachable mobile device that has its own printed circuit board (PCB), battery, processor, memory, data storage, antennas, sensors (e.g., cameras), or other electronic components. A “cradle” may refer to a securing or docking component into which the capsule may be inserted and/or interlocked. The cradle may have its own PCB, battery, processor, memory, data storage, antennas, sensors, or other electronic components. When the capsule is interlocked with or otherwise attached to the cradle, the embodiments herein may ensure that the antennas and other components of the capsule continue to function at a minimum level or even increase in their operational efficiency.

In some cases, a cradle may be attached to a wrist strap that is worn around a user's wrist. Such cradles may include their own batteries, PCBs, and other components. The PCBs may include sensors, for example, to sense the user's heart rate or oxygen level. Because the cradle device has its own PCB, these sensors may continue to function even when the corresponding capsule is detached. In some cases, the battery and/or the PCB may interfere with antennas in the detachable capsules when the capsule is docked.

The embodiments described herein may add a radiating element to the cradle that is connected to the cradle's PCB. This radiating element may be referred to herein as a “cradle patch.” The cradle patch may be positioned on the inner surface of the housing of the cradle. The cradle patch may also be connected to the PCB of the capsule via an electrical connection (e.g., a 6-pin connector that implements two grounding pins at each end of the connector). As such, the cradle patch may function as an extended ground structure for the capsule and one or more of its associated antennas. This extended ground structure may increase antenna efficiency for the antennas of the corresponding capsule by effectively adding a larger radiating surface to those antennas that are connected to the cradle patch. The extended ground structure may also provide heat reduction for the overall active system of the capsule. In some cases, the dimensions of the cradle patch may be altered to tune the cradle patch to operate more efficiently with specific antennas. Indeed, some simulations of the cradle patch have shown a 4-6 dB increase in antenna efficiency when the cradle patches are used in a cradle device.

Features from any of the embodiments described herein may be used in combination with one another in accordance with the general principles described herein. These and other embodiments, features, and advantages will be more fully understood upon reading the following detailed description in conjunction with the accompanying drawings and claims.

Mobile electronic devices often use many different types of antennas for communication on different frequency bands. For instance, current smartwatches may implement wide- and multi-band long-term evolution (LTE), global positioning system (GPS), wireless fidelity (WiFi), Bluetooth™, near field communication (NFC), or other types of antennas. These different types of antennas may provide long- and short-range communications with other electronic devices and with networks such as cellular networks or the internet.

However, as mobile devices become ever smaller, the amount of space available for these different types of antennas may be limited. Moreover, because of the small size, the amount of bandwidth achievable on any given antenna may be limited. Still further, because mobile devices such as smartwatches are often designed with metal enclosures, placing multiple different types of antennas in different locations where they can receive sufficient operational signal strength may be complicated. In some instances, the size of the mobile device may be increased to accommodate larger antennas. This increased size may, at least in some cases, improve antenna bandwidth and efficiency. However, larger sizes for smartwatches and other mobile devices may be less desirable, as additional weight and bulk in a mobile (especially wearable) device are typically unwanted. Still further, having a metal enclosure may limit how and where different types of antennas may be placed and operated within a mobile device.

As noted above, wearable devices may be configured to be worn on a user's body, such as on a user's wrist or arm. Such wearable devices may be configured to perform a variety of functions. A wristband system, for example, may be an electronic device worn on a user's wrist that performs functions such as delivering content to the user, executing social media applications, executing artificial-reality applications, messaging, web browsing, sensing ambient conditions, interfacing with head-mounted displays, monitoring the health status associated with the user, etc. In some examples, a wristband system may include a watch band that detachably couples to a watch body. The watch body may include a coupling mechanism for electrically and mechanically coupling the watch body (e.g., the enclosure or capsule) to the watch band (e.g., the cradle). At least in some cases, the wristband system may have a split architecture that allows the watch band and the watch body to operate both independently and in communication with one another. The mechanical architecture may include a coupling mechanism on the watch band and/or the watch body that allows a user to conveniently attach and detach the watch body from the watch band.

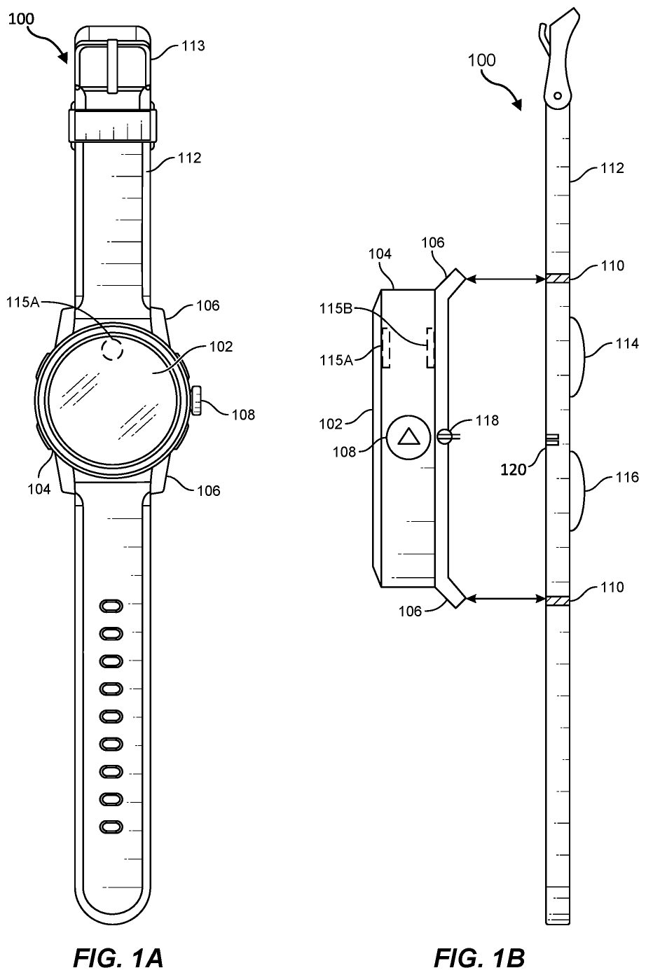

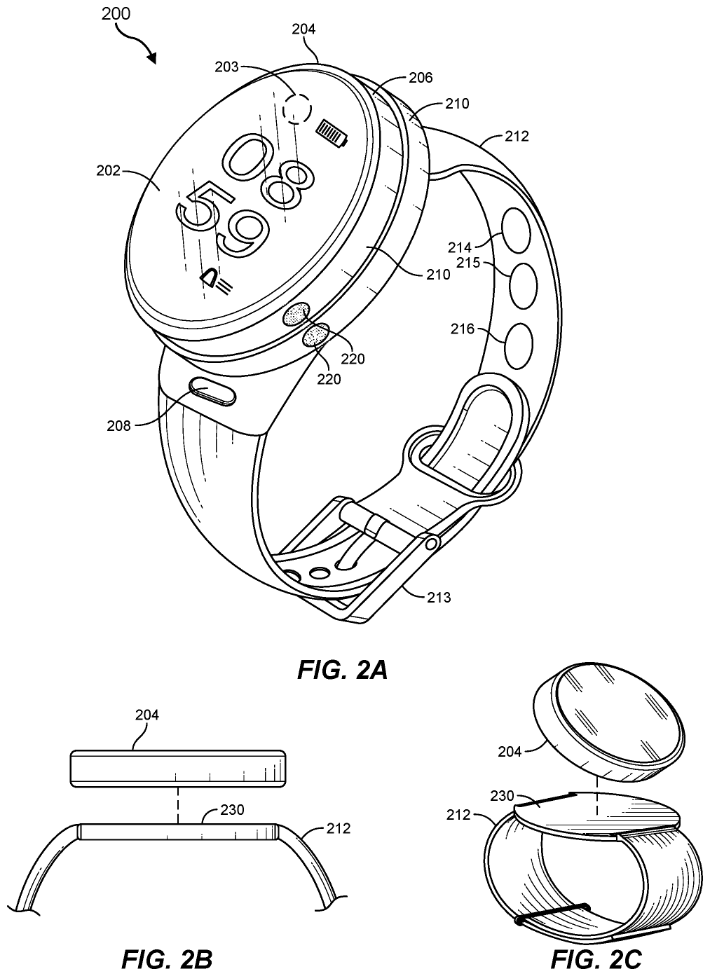

The wristband system of FIGS. 1A and 1B, for example, may be used in isolation or in conjunction with other systems including artificial-reality (AR) systems. Sensors of the wristband system (e.g., image sensors, inertial measurement units (IMUs), etc.) may be used, for example, to enhance an AR application running on the AR system. Further, the watch band may include sensors that measure biometrics of the user. For example, the watch band may include neuromuscular sensors disposed on an inside surface of the watch band contacting the user that detects the muscle intentions of the user. The AR system may include a head-mounted display that is configured to enhance a user interaction with an object within the AR environment based on the muscle intentions of the user. Signals sensed by the neuromuscular sensors may be processed and used to provide a user with an enhanced interaction with a physical object and/or a virtual object in an AR environment. For example, the AR system may operate in conjunction with the neuromuscular sensors to overlay one or more visual indicators on or near an object within the AR environment such that the user could perform “enhanced” or “augmented” interactions with the object.

FIGS. 1A and 1B illustrate an embodiment of a wristband system including a watch band and a watch body. In some cases, neuromuscular sensors may be integrated within the wristband system, as shown in FIGS. 2A, 2B, and 2C. FIG. 1A illustrates an example wristband system 100 that includes a watch body 104 coupled to a watch band 112. Watch body 104 and watch band 112 may have any size and/or shape that is configured to allow a user to wear wristband system 100 on a body part (e.g., a wrist). Wristband system 100 may include a retaining mechanism 113 (e.g., a buckle) for securing watch band 112 to the user's wrist. Wristband system 100 may also include a coupling mechanism 106, 110 for detachably coupling watch body 104 to watch band 112. Still further, the wristband system 100 may include a button or wheel 108 that allows users to interact with the wristband system 100 including applications that run on the system.

Wristband system 100 may perform various functions associated with the user. The functions may be executed independently in watch body 104, independently in watch band 112, and/or in communication between watch body 104 and watch band 112. Watch band 112 and its associated antennas may be configured to operate independently (e.g., execute functions independently) from watch body 104. Additionally or alternatively, watch body 104 and its associated antennas may be configured to operate independently (e.g., execute functions independently) from watch band 112. At least in some cases, watch band 112 and/or watch body 104 may each include the independent resources required to independently execute functions. For example, watch band 112 and/or watch body 104 may each include a power source (e.g., a battery), a memory, data storage, a processor (e.g., a CPU), communications (including multiple different types of antennas), a light source (e.g., at least one infrared LED for tracking watch body 104 and/or watch band 112 in space with an external sensor), and/or input/output devices.

FIG. 1B illustrates an example wristband system 100 that includes a watch body 104 decoupled from a watch band 112. Watch band 112 may be donned (e.g., worn) on a body part (e.g., a wrist) of a user and may operate independently from watch body 104. For example, watch band 112 may be configured to be worn by a user and an inner surface of watch band 112 may be in contact with the user's skin. When worn by a user, sensor 114 may be in contact with the user's skin. Sensor 114 may be a biosensor that senses a user's heart rate, bioimpedance, saturated oxygen level, temperature, sweat level, muscle intentions, steps taken, or a combination thereof. Watch band 112 may include multiple sensors 114 and 116 that may be distributed on an inside surface, in an interior volume, and/or on an outside surface of watch band 112. In some examples, watch body 104 may include an electrical connector 118 that mates with connector 120 of watch band 112 for wired communication and/or power transfer. In some examples, as will be described further below, watch body 104 and/or watch band 112 may include wireless communication devices including LTE antennas, GPS antennas, Bluetooth antennas, WiFi antennas, NFC antennas, or other types of antennas.

Wristband system 100 may include a coupling mechanism for detachably coupling watch body 104 to watch band 112. A user may detach watch body 104 from watch band 112 in order to reduce the encumbrance of wristband system 100 to the user. Detaching watch body 104 from watch band 112 may reduce a physical profile and/or a weight of wristband system 100. Wristband system 100 may include a watch body coupling mechanism(s) 106 and/or a watch band coupling mechanism(s) 110. A user may perform any type of motion to couple watch body 104 to watch band 112 and to decouple watch body 104 from watch band 112. For example, a user may twist, slide, turn, push, pull, or rotate watch body 104 relative to watch band 112, or a combination thereof, to attach watch body 104 to watch band 112 and to detach watch body 104 from watch band 112.

As illustrated in FIG. 1B, in some examples, watch body 104 may include front-facing image sensor 115A and rear-facing image sensor 115B. Front-facing image sensor 115A may be located in a front face of watch body 104 (e.g., substantially near, under, or on the display 102), and rear-facing image sensor 115B may be located in a rear face of watch body 104. In some examples, a level of functionality of at least one of watch band 112 or watch body 104 may be modified when watch body 104 is detached from watch band 112. The level of functionality that may be modified may include the functionality of front-facing image sensor 115A and/or rear-facing image sensor 115B. Alternatively, the level of functionality may be modified to change how the various antennas within the system. For instance, as will be described further below, the embodiments herein may include a cosmetic RF transparent feature that may form a functional link between wrist strap antennas and internal electronic components including tuners, amplifiers, controllers, and data processors.

FIG. 2A illustrates a perspective view of an example wristband system 200 that includes a watch body 204 decoupled from a watch band 212. Wristband system 200 may be structured and/or function similarly to wristband system 100 of FIGS. 1A and 1B. Watch body 204 and watch band 212 may have a substantially rectangular or circular shape and may be configured to allow a user to wear wristband system 200 on a body part (e.g., a wrist). Wristband system 200 may include a retaining mechanism 213 (e.g., a buckle, a hook and loop fastener, etc.) for securing watch band 212 to the user's wrist. Wristband system 200 may also include a coupling mechanism 208 for detachably coupling watch body 204 to watch band 212. The watch body 204 may include an enclosure 206 that houses various electronic components. In some cases, the watch body 204 may be referred to as a “capsule.”

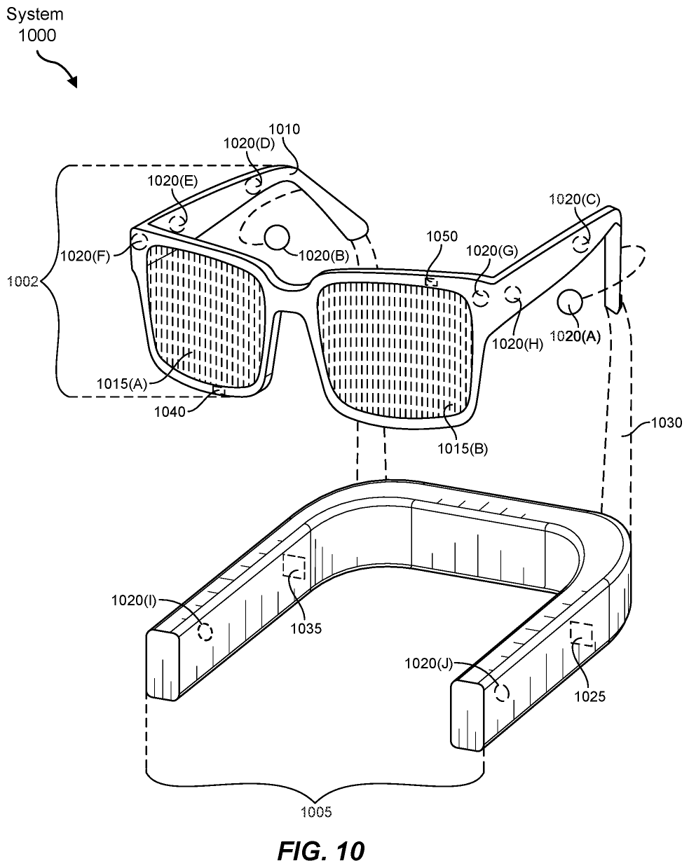

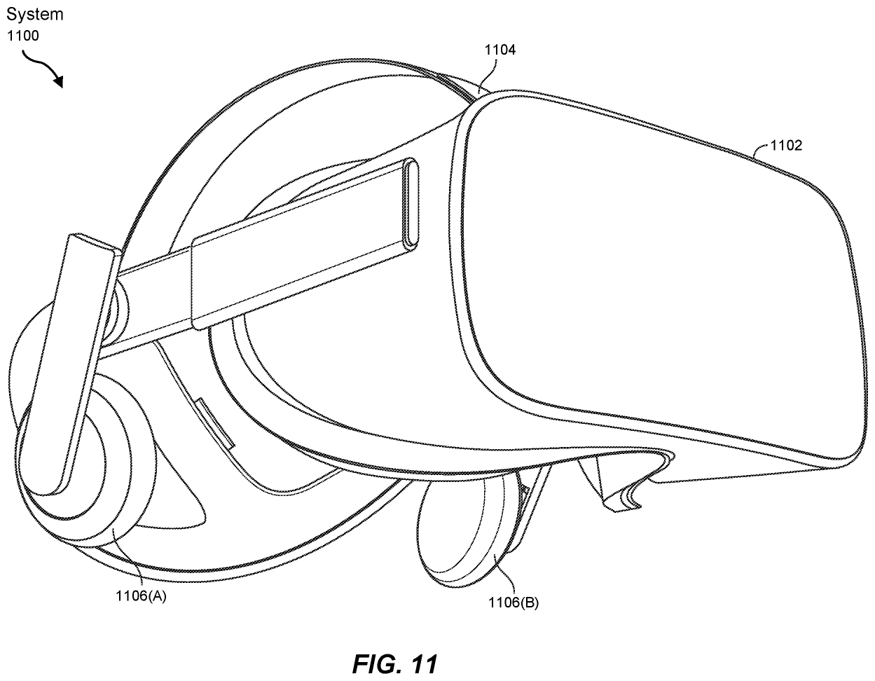

Wristband system 200 may perform various functions associated with the user as described above with reference to FIGS. 1A and 1B. The functions executed by wristband system 200 may include, without limitation, display of visual content to the user (e.g., visual content displayed on display screen 202), sensing user input (e.g., sensing a touch on a touch bezel 210 or on a physical button, sensing biometric data on sensor 214, sensing neuromuscular signals on neuromuscular sensors 215 or 216, sensing audio input via microphones 220, etc.), messaging (e.g., text, speech, video, etc.), image capture (e.g., with a front-facing image sensor 203 and/or a rear-facing image sensor), wireless communications (e.g., cellular, near field, WiFi, personal area network, etc.), location determination, financial transactions, providing haptic feedback, alarms, notifications, biometric authentication, health monitoring, sleep monitoring, etc. These functions may be executed independently in watch body 204, independently in watch band 212, and/or in communication between watch body 204 and watch band 212. Functions may be executed on wristband system 200 in conjunction with an artificial-reality system such as the artificial-reality systems described in FIGS. 9 and 10.

Watch band 212 may be configured to be worn by a user such that an inner surface of watch band 212 may be in contact with the user's skin. When worn by a user, sensor 214 may be in contact with the user's skin. Sensor 214 may be a biosensor that senses a user's heart rate, saturated oxygen level, temperature, sweat level, muscle intentions, or a combination thereof. Watch band 212 may include multiple sensors 214 that may be distributed on an inside and/or an outside surface of watch band 212. Additionally or alternatively, watch body 204 may include the same or different sensors than watch band 212. For example, multiple sensors may be distributed on an inside and/or an outside surface of watch body 204 or on the surface of the wrist straps. The watch body 204 may include, without limitation, front-facing image sensor 115A, rear-facing image sensor 115B, a biometric sensor, an IMU, a heart rate sensor, a saturated oxygen sensor, a neuromuscular sensor(s), an altimeter sensor, a temperature sensor, a bioimpedance sensor, a pedometer sensor, an optical sensor, a touch sensor, a sweat sensor, etc.

Watch band 212 may transmit the data acquired by sensor 214 to watch body 204 using a wired communication method (e.g., a UART, a USB transceiver, etc.) and/or a wireless communication method (e.g., near field communication, Bluetooth™, etc.). Watch band 212 may be configured to operate (e.g., to collect data using sensor 214) independent of whether watch body 204 is coupled to or decoupled from watch band 212. In some examples, watch band 212 may include a neuromuscular sensor 215 (e.g., an electromyography (EMG) sensor, a mechanomyogram (MMG) sensor, a sonomyography (SMG) sensor, etc.). Neuromuscular sensor 215 may sense a user's muscle intention.

FIG. 2B is a side view and FIG. 2C is a perspective view of another example wristband system. The wristband systems of FIGS. 2B and 2C may include a watch body interface 230 or “cradle.” Watch body 204 may be detachably coupled to watch body interface 230. In additional examples, one or more electronic components may be housed in watch body interface 230 and one or more other electronic components may be housed in portions of watch band 212 away from watch body interface 230.

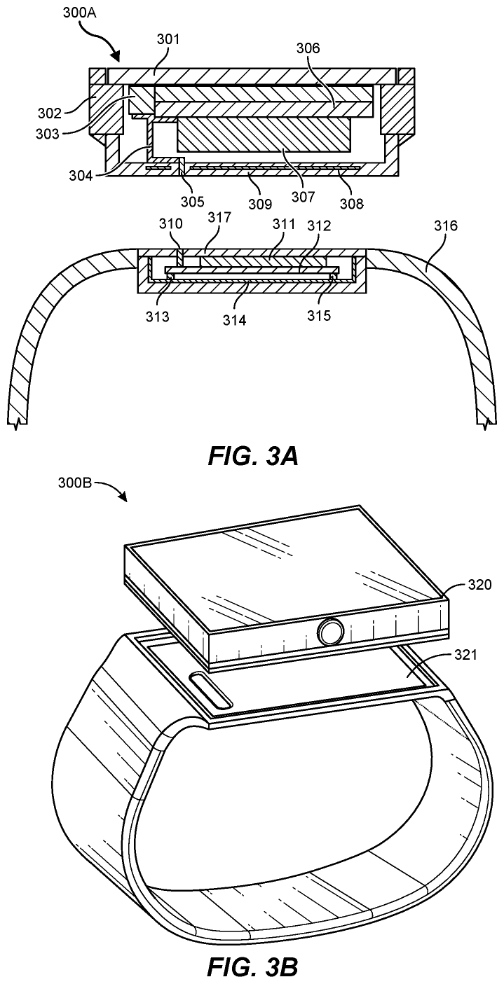

The following will provide, with reference to FIGS. 3-12, detailed descriptions of systems and wearable electronic devices that implement different antenna architectures in different scenarios. Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 3A illustrates an embodiment of a system 300A that may include multiple different antennas and other electronic components. The system 300A may be a mobile electronic device or may be a portion of an electronic device. In some examples, the system 300A may be a bezel or capsule portion of a smartwatch. As noted above, this capsule may be detachable from a wristband cradle that is designed to receive and hold the capsule. In other cases, it should be noted, the antenna architectures and embodiments described herein may be applied to other mobile devices including augmented reality devices (e.g., as shown in FIG. 11), virtual reality devices (e.g., as shown in FIG. 12), smartphones, tablets, Internet of Things devices, wearable electronic devices, gaming devices, or other electronic devices.

The system 300A may include an enclosure 302. The enclosure 302 may form the structural housing for the upper capsule portion of the system. The enclosure 302 may be metallic, or may be made of another type of conductive material such as a conductive polymer. The enclosure may be conductive over its entirety, or may be conductive only in certain portions (e.g., the sides, the top, the bottom, etc.). In some cases, the system 300A may include a bottom cover portion 309 that is made of plastic or other nonconductive material. This bottom cover portion 309 may attach to the conductive enclosure 302 and may include apertures for the various sensors that may be implemented in the bottom portion of the mobile device. The system 300A may include a display 301 such as a touchscreen organic light emitting diode (OLED) display or other type of display. Still further, the system 300A may include a main logic board or PCB 306. The PCB may include many different components connected thereto including a battery 307, a camera 303, an antenna (e.g., 308), or other components (e.g., data storage or memory). In some cases, the camera, the PCB 306, or other components may be electrically connected to a charging pin 305 via a flex connector 304 or other type of electrical connector.

Still further, the system 300A may include a cradle portion. The cradle portion may be secured to a user's wrist via wrist straps 316. The cradle portion may include a housing 317 that may surround some or all of the cradle's internal components. The cradle may include a battery 311, a PCB 312, and a cradle patch 314. The cradle patch 314 may extend along all or a portion of the inner bottom surface of the cradle. In some cases, the cradle patch 314 may include one or more electrical connections to the cradle PCB 312 (e.g., 313 and 315). Other electrical connections may also be used. In some cases, the cradle PCB 312 to which the cradle patch 314 is connected may, itself, be connected to the capsule portion via a charging pin 310 or other electrical connection. The charging pin 310 of the cradle may, for example connect to the charging pin 305 of the capsule 320.

In this manner, the capsule and cradle may share data, resources, battery power, and antennas. Indeed, in some cases, the cradle patch 314 may act as a radiating element for the antenna 308 (or for other antennas implemented in the capsule portion or in the cradle portion). In some cases, a controller or processor may select which antenna is to be electrically connected to the cradle patch 314 through the charging pins 305/310. Thus, in some cases, an LTE low band antenna may be connected to the cradle patch, while in other cases, an LTE mid/high band antenna, a GPS antenna, a WiFi antenna, a Bluetooth antenna, or other type of antenna may be connected to and may implement the cradle patch 314 as an extended radiating element. In some cases, the controller or processor may determine which antenna is using the cradle patch based on current context including determining which antenna has the most need for the efficiency gains provided by the cradle patch (e.g., which antenna has the weakest connection or the most path loss, etc.). This cradle patch 314 may allow the antennas of the capsule 320 to operate at the same (or better) operational efficiency when attached to the cradle 321 as they would when the capsule is detached. In this manner, users may attach or detach the capsule at will and experience little or no change in antenna operation.

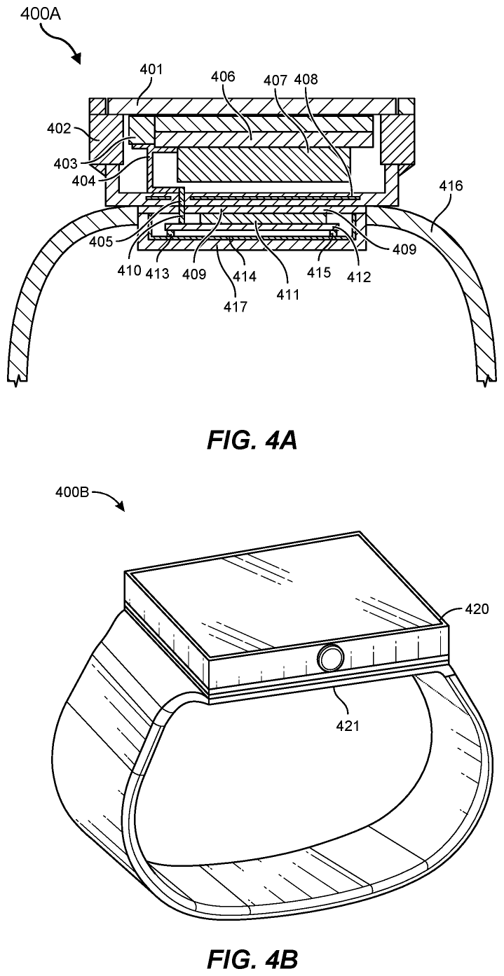

The cross-sectional view of FIG. 3A may be further visualized in the perspective view shown in FIG. 3B. The system 300B may include a capsule portion 320 and a cradle portion 321. The capsule portion 320 may be configured to operate on its own, without a device cradle. Similarly, the cradle portion 321 may be configured to operate on its own, without a capsule 320. The embodiments described herein may allow the antenna functionality of each portion of the system 300B to continue operating at a minimum (or higher) efficiency level, even when the two components are secured together. The cradle patch 314 may provide an extended radiating element that may help to make up for losses in antenna efficiency that may otherwise occur when the antennas of the capsule portion 320 are positioned close to the battery, PCB, and other components of the cradle that may interfere with the capsule's antennas. FIGS. 4A and 4B illustrate such an embodiment in which the capsule portion and cradle portion are secured to each other.

For example, FIG. 4A illustrates an embodiment of a mobile electronic device 400A that may include various electronic and mechanical components. For instance, the mobile electronic device 400A may include a display 401 such as a touchscreen display. The mobile electronic device 400A may also include an outer housing 402 that may be made of a conductive material such as metal. The outer housing 402 may be connected to a back cover portion that may include an antenna 408 and a charging pin 405 or other type of electrical connection between the capsule 420 (see embodiment 400B of FIG. 4B) and the cradle 421. The capsule 420 may further include a main PCB 407 with one or more components affixed thereto including a camera 403, a battery 407, and a flex connector 404, among other components. The flex connector 404 may connect the PCB 406 and/or other components to a charging pin 405. The charging pin 405 may electrically connect to the charging pin 410 of the cradle 421. In some cases, the connection between charging pins 405 and 410 may transfer electricity for charging. Additionally or alternatively, the connection may, at least in some cases, transfer data or other signals between the capsule 420 and the cradle 421.

The back cover of the capsule 420 may rest on a top surface 409 of the cradle 421. The cradle may include one or more sensors that are operated by a cradle PCB 412 and powered by a cradle battery 411. The cradle 421 may be held in place on the user's wrist (or at another position on the user's body) using a wrist strap 416. Underneath the cradle PCB 412 may lie a cradle patch. The cradle patch 414 may extend along all or a portion of the inner bottom surface 417 of the cradle 421. In some cases, the cradle patch 414 may include one or more electrical connections to the cradle PCB 412. In the embodiment shown in FIG. 4A, there may be two connections to the PCB 412, connections 413 and 415. Although two connections are shown, more or fewer connections may be used.

In some cases, the cradle PCB 412 to which the cradle patch 414 is connected may, itself, be connected to the capsule 420 via a charging pin 410 or other electrical connection. The charging pin 410 of the cradle 421 may connect to the charging pin 405 of the capsule 420. In this manner, the capsule 420 and cradle 421 may share or otherwise provide access to data, resources, battery power, antennas, cameras, or other components. The cradle patch 414 may be designed to act as a radiating element for the antenna 408 or for other antennas that may be implemented in the capsule 420 or in the cradle 421. The antenna 408 (e.g., a low band LTE antenna) may be designed to operate in a certain manner when the capsule is detached from the cradle. However, when the capsule 420 is attached to the cradle 421, the cradle patch 414 may allow the antenna 408 to operate at the same (or better) operational efficiency when attached to the capsule as when the capsule is detached from the cradle. As such, users may attach or detach the capsule in different circumstances and may experience little or no change in the operation of antenna 408.

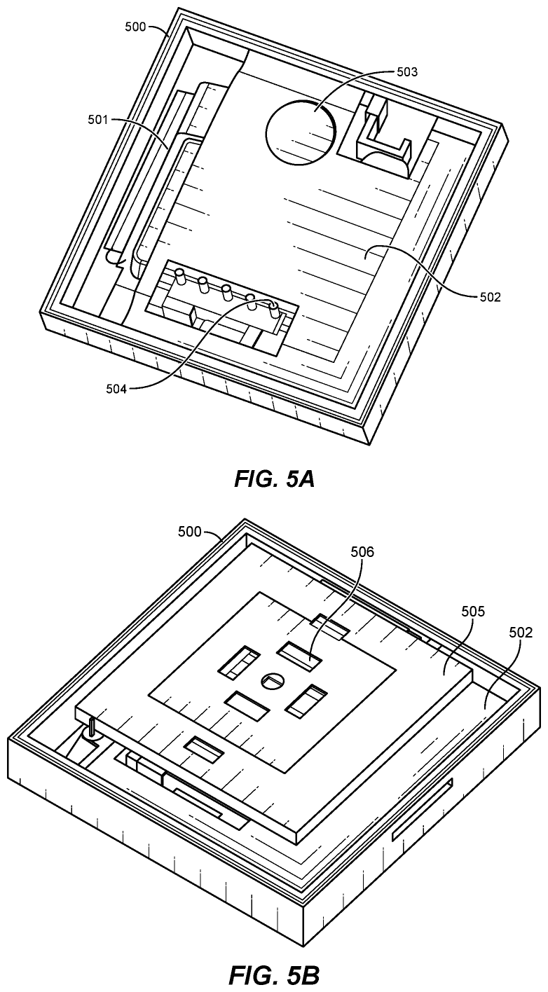

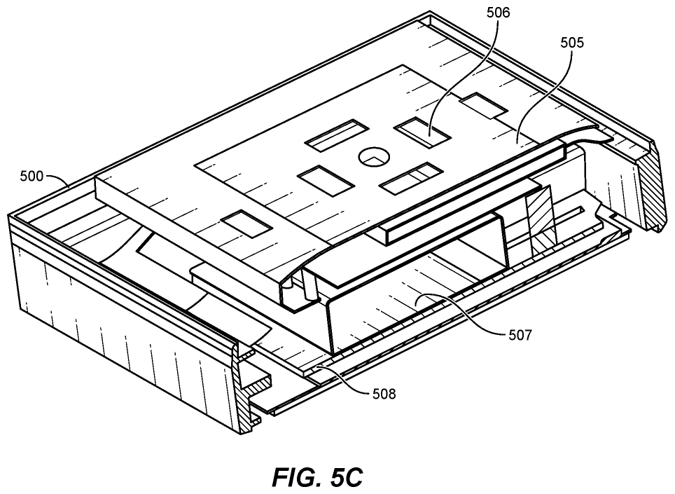

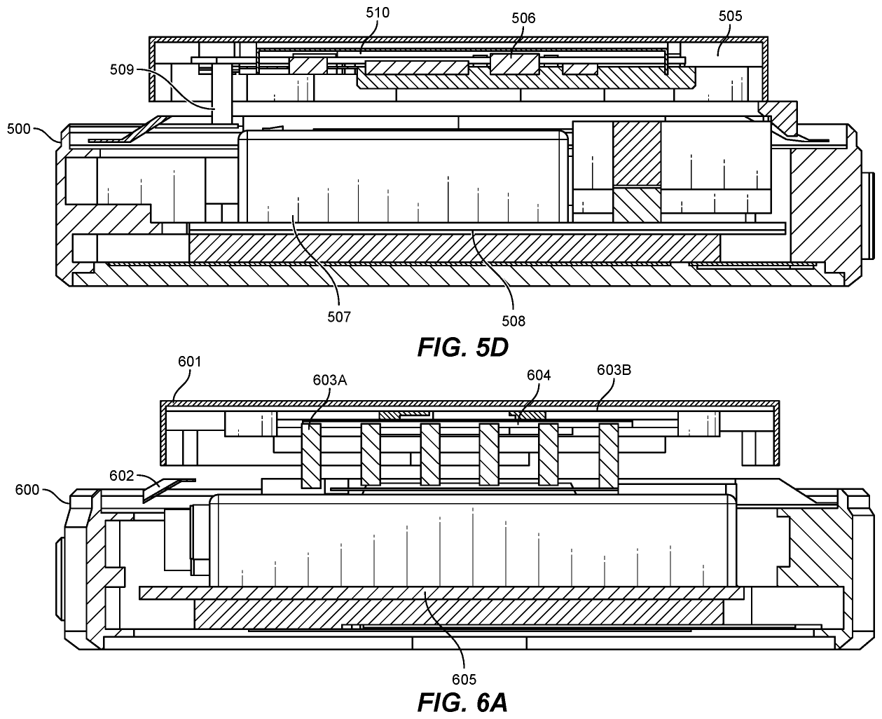

FIGS. 5A-5D illustrate embodiments of a system with and without a cradle patch. For instance, system 500 of FIG. 5A may include a capsule portion of a mobile electronic device. The capsule portion of the system may include various antennas (e.g., 501 and 502. In some embodiments, the antenna 501 may be a GPS antenna, while the antenna 502 may be an LTE antenna. In the embodiment shown in FIG. 5A, the antenna 502 may include an aperture 503 for a camera or for other sensors. The capsule portion may also have various charging pins 504. As noted above, these pins may represent substantially any type of electrical connection between the capsule and the cradle, including direct, Ohmic connections, as well as indirect, capacitive connections. The charging pins 504 may allow the transfer of electricity, data, control signals, or similar. In some cases, the cradle portion shown may be configured for coupling to a cradle portion. The cradle may receive and secure the detachable capsule shown in FIG. 5A.

FIG. 5B illustrates an embodiment of the system 500 in which a cradle patch 505 has been connected to the capsule. The cradle patch 505 may be shaped as shown, or may include different shapes. In some cases, the cradle patch 505 may include apertures 506 to provide sensor access to the user's skin or to provide other functions. In some cases, the cradle patch 505 may surround a printed circuit board that is mounted within the cradle. The cradle patch 505 may comprise a radiating structure that is positioned on an inner surface of the housing of the cradle (e.g., element 417 of FIG. 4A). This radiating structure may be electrically connected to the PCB that is mounted within the cradle.

FIG. 5C illustrates a cross-sectional perspective view of the system 500. In this view, the extent of the cradle patch 505 may be seen. In this embodiment, the cradle patch 505 extends along the entirety of the inner surface of the bottom cover of the cradle and wraps around the sides upward (relative to the smartwatch's as-worn position). Although shown as extending along the entirety of the inner surface of the bottom cover of the cradle, it will be understood that the cradle patch may extend along only a portion of this inner surface. Indeed, as will be explained further below, the cradle patch may be formed in a strip, or in an “x” shape, or in a round shape or other shape. As shown in the side cross-sectional view of FIG. 5D, the cradle patch 505 and/or the cradle PCB 510 may electrically connect to the capsule via a charging pin 509 or other electrical connector. This electrical connection may extend to the main PCB 508 and/or to other components such as the battery 507.

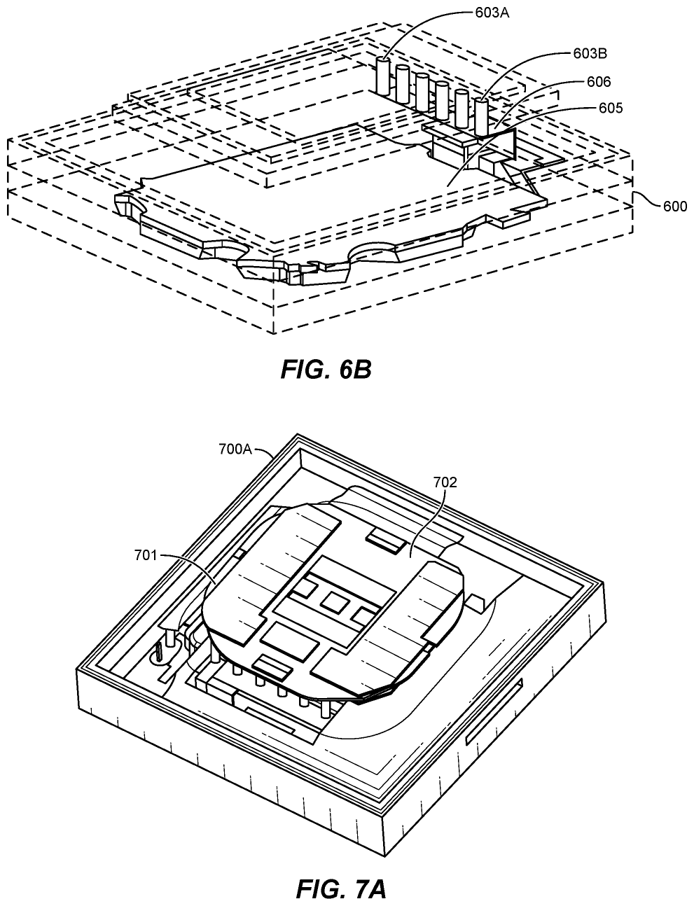

In some cases, as shown in the side cross-sectional view of FIG. 6, a capsule 600 may be attached to the cradle (or more specifically to the cradle PCB 604) via a 6-pin connector. In some embodiments, the two far pins 603A and 603B on either side of the 6-pin connector may be grounding pins. The cradle patch 601 of the cradle portion may be connected to the cradle PCB 604 and, thus, may itself connect to the capsule 600 via the 6-pin connector. As such, the cradle patch 601 may be electrically connected to antennas of the capsule (e.g., 602) and/or to the main PCB of the capsule (e.g., 605). FIG. 6B illustrates a side view of the capsule portion in which a 6-pin connector 606 is connected via a flex connector to the capsule's main PCB 605. While a flex connector or flex assembly is shown in FIG. 6B, it will be understood that substantially any type of electrical connector between the main PCB 605 and the cradle may be used.

As noted above, the capsule portion and the cradle portion may each be used separately, without the other. Each may include its own power source, processor, memory, data storage, antennas, or other components. When connected together (e.g., via the 6-pin connector 606), the cradle patch's radiating structure positioned on the inner surface of the cradle may be used by or in conjunction with the antennas of the capsule. Thus, for instance, antenna 602 may electrically connect to the cradle patch 601 through the main PCB 605, through the 6-pin connector 606, through the cradle PCB 604, and to the cradle patch 601. As such, the antenna 602 (or other antennas of the capsule or of the cradle) may implement the cradle patch 601 as an extended radiating surface that may allow those antennas to operate more efficiently. In this manner, the antennas may use less power while transmitting and receiving, and may still provide a sufficiently strong signal. Using less power may allow the mobile device to last longer on a battery charge and may lose less power due to heat. These combined savings may be significant when dealing with smartwatches or other relatively small mobile electronic devices.

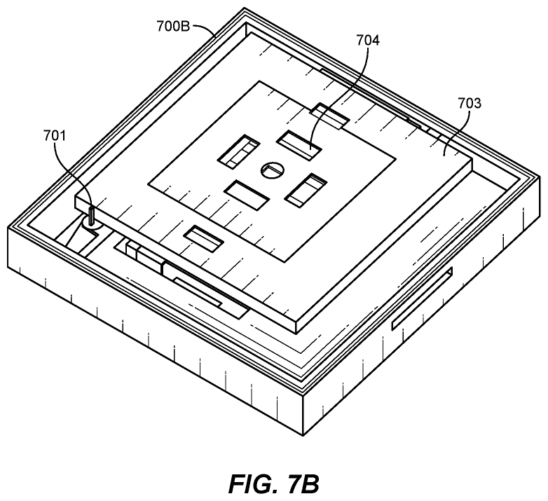

FIGS. 7A and 7B illustrate embodiments 700A and 700B, respectively, that show a capsule portion 701 attached to a cradle portion 702. In embodiment 700A, however, the capsule portion 701 is attached to a cradle portion 702 that does not include a cradle patch 703. Thus, the cradle portion 702 is shown with a printed circuit board and various sensors or other components. Embodiment 700B of FIG. 7B, on the other hand, illustrates the capsule portion 701 attached to a cradle portion 702, but in this instance, the cradle portion is substantially surrounded by a cradle patch 703 (except for the various apertures 704 that may be provided for sensors). In this embodiment, the cradle patch may cover substantially the entire printed circuit board of the cradle and may wrap around the sides of the PCB. In other cases, the cradle patch may take different shapes. Still further, the cradle patch 703 may be placed in different positions relative to the (plastic) back cover of the mobile device. In some cases, the cradle patch may be place on the inner surface of the back cover. In other cases, the cradle patch may be embedded within the back cover of the mobile device. Alternatively, in some examples, the cradle patch may be placed on the outer surface of cradle's housing.

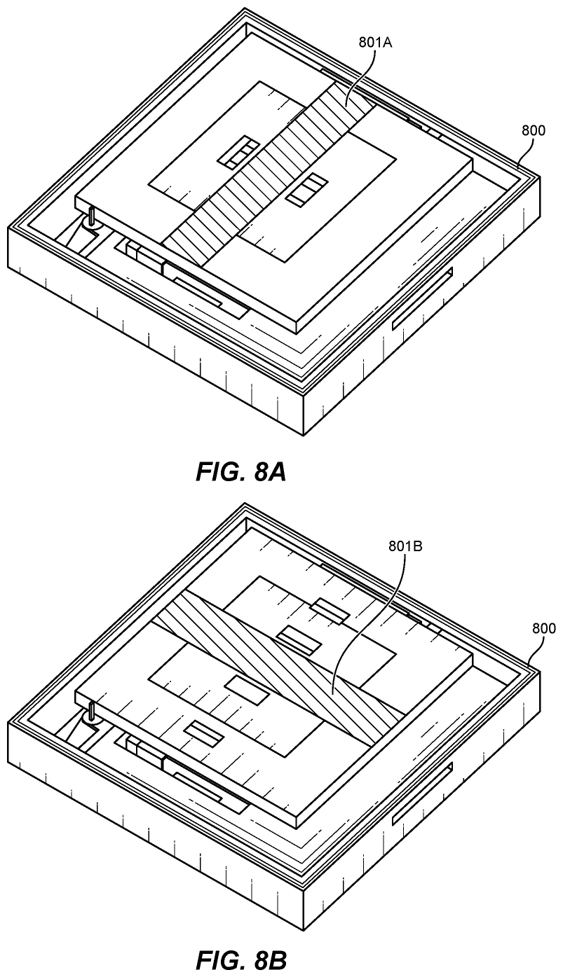

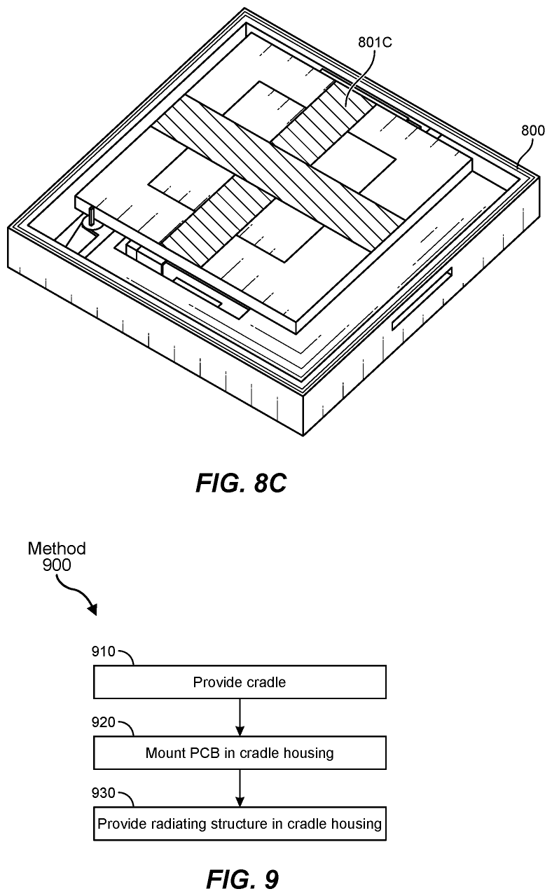

In some embodiments, various characteristics of the cradle patch's radiating structure may be altered to change different capsule antenna characteristics. For instance, in some cases, the height, width, or depth dimension of the radiating structure may be changed to improve capsule antenna efficiency. In some embodiments, for example, as shown in FIG. 8A, the cradle patch 801A of capsule 800 may be formed in a lengthwise strip that runs in parallel to a user's arm. In the embodiment of FIG. 8B, the cradle patch 801B may be formed in an opposite lengthwise strip that runs perpendicular to the user's arm. Other shapes or sizes may also be used, such as the “x” shaped cradle patch 801C of FIG. 8C. Other shapes, including squares, rectangles, circles, triangles, hexagons, or other shapes may be used. Similarly, different thicknesses either throughout or in patterns may be used on the cradle patch. In some cases, the different shapes or thicknesses or designs may correspond to different types of antennas. Thus, LTE antennas or GPS antennas may use one style or shape of cradle patch, while mid band LTE antennas or WiFi antennas may use a different style or shape of cradle patch. Thus, the cradle patch may be specifically designed for each implementation and may bolster the radiating characteristics of the antenna(s) that are connected to it.

FIG. 9 is a flow diagram of a method of manufacturing for providing, forming, creating, or otherwise generating a mobile device that includes one or more of the antenna architectures described herein. The steps shown in FIG. 9 may be performed by any suitable manufacturing equipment, including 3D printers, and may be controlled via computer-executable code and/or networked computing systems. In one example, each of the steps shown in FIG. 9 may represent an algorithm whose structure includes and/or is represented by multiple sub-steps, examples of which will be provided in greater detail below.

Step 910 of Method 900 of FIG. 9, for example, may include providing a cradle (e.g., 321 of FIG. 3) configured to receive and secure a detachable capsule (e.g., 320). Step 920 of Method 900 may include mounting a printed circuit board (e.g., 312) within a housing (e.g., 417) of the cradle. Still further, step 930 of Method 900 may include providing a radiating structure (e.g., 314) that is positioned on an inner surface of the housing of the cradle. The cradle patch's radiating structure 314 may be electrically connected to the cradle PCB 312. The resulting structure may be a mobile electronic device that is configured to receive and transmit wireless signals.

In some cases, in addition to improving antenna characteristics, the cradle patch's radiating structure may be configured to dissipate heat from various electronic components of the cradle. Thus, the cradle patch may dissipate heat from the battery 311, from various processors or amplifiers on the cradle PCB 312, or from electronic components in the capsule. In some embodiments, the method of manufacturing may produce a capsule that may have a continuous outer conductive housing, while in other cases, the capsule may have a split conductive housing. The split housing may, at least in some cases, provide for improved antenna efficiencies at some frequencies. In this manner, the method of manufacturing described above may produce mobile electronic devices that have improved antenna efficiency and other characteristics due to the extended radiating surface provided by the cradle patch.

### Example Embodiments

Example 1: A system comprising: a cradle configured to receive and secure a detachable capsule, a printed circuit board mounted within a housing of the cradle, and a radiating structure positioned on an inner surface of the housing of the cradle, wherein the radiating structure is electrically connected to the PCB of the cradle.
Example 2: The system of Example 1, wherein the cradle is usable in an attached mode in which the capsule is attached to the cradle.
Example 3: The system of Example 1 or Example 2, wherein the radiating structure positioned on the inner surface of the housing of the cradle is implemented in conjunction with at least one antenna of the capsule.
Example 4: The system of any of Examples 1-3, wherein the cradle is usable in a detached mode in which the capsule is detached from the cradle.
Example 5: The system of any of Examples 1-4, wherein the cradle provides limited functions when the capsule is detached from the cradle.
Example 6: The system of any of Examples 1-5, wherein the radiating structure is connected to a printed circuit board of the capsule via a connector.
Example 7: The system of any of Examples 1-6, wherein the radiating structure is connected to a printed circuit board of the capsule via a 6-pin connector-flex assembly.
Example 8: The system of any of Examples 1-7, wherein the 6-pin connector-flex assembly implements two grounding pins, spaced apart at each end of the 6-pin connector-flex assembly.
Example 9: The system of any of Examples 1-8, wherein one or more characteristics of the radiating structure are altered to change one or more capsule antenna characteristics.
Example 10: The system of any of Examples 1-9, wherein at least one of a height, width, or depth dimension of the radiating structure are changed to affect capsule antenna efficiency.
Example 11: The system of any of Examples 1-10, wherein the radiating structure is embedded within the housing of the cradle.
Example 12: The system of any of Examples 1-11, wherein the housing of the cradle is made of a conductive material.
Example 13: A mobile electronic device comprising: a cradle configured to receive and secure a detachable capsule, a printed circuit board mounted within a housing of the cradle, and a radiating structure positioned on an inner surface of the housing of the cradle, wherein the radiating structure is electrically connected to the PCB of the cradle.
Example 14: The mobile electronic device of Example 13, wherein the radiating structure comprises an extended ground structure that is optimizable for specific types of capsules.
Example 15: The mobile electronic device of Example 13 or Example 14, wherein the type of capsule comprises a capsule having a split conductive housing.
Example 16: The mobile electronic device of any of Examples 13-15, wherein the radiating structure is configured to dissipate heat from one or more electronic components of the cradle.
Example 17: The mobile electronic device of any of Examples 13-16, wherein the cradle includes a ground connection, and wherein the ground connection in the cradle couples to at least one antenna in the capsule.
Example 18: The mobile electronic device of any of Examples 13-17, wherein differently shaped radiating structures are used for different antenna types in the capsule.
Example 19: The mobile electronic device of any of Examples 13-18, wherein the mobile electronic device comprises a smartwatch.
Example 20: A method of manufacturing comprising: providing a cradle configured to receive and secure a detachable capsule, mounting a printed circuit board within a housing of the cradle, and providing a radiating structure that is positioned on an inner surface of the housing of the cradle, wherein the radiating structure is electrically connected to the PCB of the cradle.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented reality system 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(l) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(l) and 1020(J) may be positioned on neckband 1005, thereby increasing the distance between the neckband acoustic transducers 1020(l) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium-ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light projector (DLP) micro-displays, liquid crystal on silicon (LCOS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Discs (CDs), Digital Video Discs (DVDs), and BLU-RAY discs), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a cradle configured to receive and secure a detachable capsule;
a printed circuit board (PCB) mounted within a housing of the cradle; and
a radiating structure positioned on an inner surface of the housing of the cradle, wherein the radiating structure is electrically connected to the PCB of the cradle.

2. The system of claim 1, wherein the cradle is usable in an attached mode in which the capsule is attached to the cradle.

3. The system of claim 1, wherein the radiating structure positioned on the inner surface of the housing of the cradle is implemented in conjunction with at least one antenna of the capsule.

4. The system of claim 1, wherein the cradle is usable in a detached mode in which the capsule is detached from the cradle.

5. The system of claim 4, wherein the cradle provides limited functions when the capsule is detached from the cradle.

6. The system of claim 1, wherein the radiating structure is connected to a printed circuit board of the capsule via a connector.

7. The system of claim 6, wherein the radiating structure is connected to a printed circuit board of the capsule via a 6-pin connector-flex assembly.

8. The system of claim 7, wherein the 6-pin connector-flex assembly implements two grounding pins, spaced apart at each end of the 6-pin connector-flex assembly.

9. The system of claim 1, wherein one or more characteristics of the radiating structure are altered to change one or more capsule antenna characteristics.

10. The system of claim 9, wherein at least one of a height, width, or depth dimension of the radiating structure are changed to affect capsule antenna efficiency.

11. The system of claim 1, wherein the radiating structure is embedded within the housing of the cradle.

12. The system of claim 1, wherein the housing of the cradle is made of a conductive material.

13. A mobile electronic device comprising:
a cradle configured to receive and secure a detachable capsule;
a printed circuit board (PCB) mounted within a housing of the cradle; and
a radiating structure positioned on an inner surface of the housing of the cradle, wherein the radiating structure is electrically connected to the PCB of the cradle.

14. The mobile electronic device of claim 13, wherein the radiating structure comprises an extended ground structure that is optimizable for specific types of capsules.

15. The mobile electronic device of claim 14, wherein the type of capsule comprises a capsule having a split conductive housing.

16. The mobile electronic device of claim 13, wherein the radiating structure is configured to dissipate heat from one or more electronic components of the cradle.

17. The mobile electronic device of claim 13, wherein the cradle includes a ground connection, and wherein the ground connection in the cradle couples to at least one antenna in the capsule.

18. The mobile electronic device of claim 17, wherein differently shaped radiating structures are used for different antenna types in the capsule.

19. The mobile electronic device of claim 13, wherein the mobile electronic device comprises a smartwatch.

20. A method of manufacturing comprising:
providing a cradle configured to receive and secure a detachable capsule;
mounting a printed circuit board (PCB) within a housing of the cradle; and
providing a radiating structure that is positioned on an inner surface of the housing of the cradle, wherein the radiating structure is electrically connected to the PCB of the cradle.
